(19) United States
(12) Patent Application Publication
(10) Pub. No.: US 2026/0304486 A1
(43) Pub. Date: Oct. 1, 2026

(54) RANDOM ACCESS METHOD ANDAPPARATUS

(71) Applicant: BEIJING XIAOMI MOBILE SOFTWARE CO., LTD., Beijing (CN)

(72) Inventors: Juan ZHANG, Beijing (CN); Mingju LI, Beijing (CN); Yumin WU, Beijing (CN)

(21) Appl. No.: 18/996,609

(22) PCT Filed: Jul. 22, 2022
(86) PCT No.: PCT/CN2022/107532

§ 371 Date: Jan. 17, 2025

(51) Int. Cl. H04W 74/0833

(52) U.S. Cl. CPC H04W 74/0833

(57) ABSTRACT

A random access (RA) method, performed by a terminal, includes: in response to triggering an RA process by a terminal supporting a beam correspondence, determining at least one of a sending beam or a receiving beam of the terminal based on the beam correspondence; and transmitting at least one of information or data in the RA process triggered currently based on the at least one of the sending beam or the receiving beam of the terminal.

### CROSS-REFERENCE TO RELATED APPLICATION

This application is a U.S. national phase of International Application No. PCT/CN2022/107532, filed Jul. 22, 2022, the entire content of which is incorporated herein by reference.

### TECHNICAL FIELD

The disclosure relates to a field of wireless communication technology, and particularly to a random access method/apparatus/device and a storage medium.

### BACKGROUND

In a communication system, if a terminal in an unconnected state needs to perform communication service with a network device, the terminal usually needs to initiate a random access (RA) process to the network device, and then performs the communication service with the network device.

In the related art, the terminal may perform a signaling interaction with the network device in the RA process. For example, in a 2-step RA process, the terminal may send an msgA to the network device, and receives an msgB sent by the network device; and in a 4-step RA process, the terminal sends an msg1 and an msg3 to the network device, and receives an msg2 and an msg4 from the network device.

In the RA process, how the terminal selects a sending and/or receiving beam for sending and receiving a signaling is a technical problem that needs to be solved.

### SUMMARY

In a first aspect, an embodiment of the disclosure provides a random access (RA) method, performed by a terminal, including: in response to triggering an RA process by a terminal supporting a beam correspondence, determining at least one of a sending beam or a receiving beam of the terminal based on the beam correspondence; and transmitting at least one of information or data in the RA process triggered currently based on the at least one of the sending beam or the receiving beam of the terminal.

In a second aspect, an embodiment of the disclosure provides a random access (RA) method, performed by a network device, including: in response to triggering an RA process by a terminal, determining whether the RA process triggered by the terminal is an RA process of realizing a transmission based on a beam correspondence; in response to determining that the RA process triggered by the terminal is the RA process of realizing the transmission based on the beam correspondence, determining whether the network device intends to realize a transmission in the RA process triggered currently based on the beam correspondence of the terminal; in response to determining that the network device intends to realize the transmission in the RA process triggered currently based on the beam correspondence of the terminal, realizing a transmission of at least one of information or data in the RA process triggered currently based on the beam correspondence of the terminal; and in response to determining that the network device does not realize the transmission in the RA process triggered currently based on the beam correspondence of the terminal, realizing the transmission of the at least one of the information or the data in the RA process triggered currently based on a beam scanning.

In a third aspect, an embodiment of the disclosure provides a terminal, including: a processor and a memory for storing a computer program executable by the processor, and the processor is configured to execute the method in the first aspect above.

In a fourth aspect, an embodiment of the disclosure provides a network device, including a processor and a memory for storing a computer program executable by the processor, and the processor is configured to execute the method in the second aspect above.

### BRIEF DESCRIPTION OF THE DRAWINGS

The above and additional aspects and advantages of the disclosure will become apparent and more readily appreciated from the following descriptions made with reference to the accompanying drawings, in which:

FIG. 1 is a schematic diagram illustrating a communication system according to an embodiment of the disclosure;

FIG. 2 is a flow chart illustrating a random access method according to another embodiment of the disclosure;

FIG. 3 is a flow chart illustrating a random access method according to a still another embodiment of the disclosure;

FIG. 4 is a flow chart illustrating a random access method according to a yet another embodiment of the disclosure;

FIG. 5 is a flow chart illustrating a random access method according to another embodiment of the disclosure;

FIG. 6 is a flow chart illustrating a random access method according to a still embodiment of the disclosure;

FIG. 7 is a flow chart illustrating a random access method according to a yet another embodiment of the disclosure;

FIG. 8 is a flow chart illustrating a random access method according to an embodiment of the disclosure;

FIG. 9 is a flow chart illustrating a random access method according to another embodiment of the disclosure;

FIG. 10 is a block diagram illustrating a communication device according to an embodiment of the disclosure;

FIG. 11 is a block diagram illustrating a communication device according to another embodiment of the disclosure;

FIG. 12 is a block diagram illustrating a communication device according to an embodiment of the disclosure; and

FIG. 13 is a schematic diagram illustrating a chip according to an embodiment of the disclosure.

### DETAILED DESCRIPTION

Description will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with embodiments of the disclosure. Instead, they are merely examples of apparatuses and methods consistent with aspects related to embodiments of the disclosure as recited in the appended claims.

The terms used in embodiments of the disclosure are merely for the purpose of describing a particular embodiment and are not intended to limit embodiments of the disclosure. The terms “a” and “the” in the singular form used in embodiments and claims of the disclosure are also intended to include the plural form, unless the context clearly indicates other meaning. It should also be understood that the term “and/or” as used herein refers to any or all possible combinations of one or more associated listed items.

It should be understood that although the terms first, second, third, etc. may be used to describe various information in embodiments of the disclosure, such information should not be limited to these terms. These terms are merely used to distinguish information in the same type from one another. For example, without leaving the scope of embodiments of the disclosure, the first information may also be referred to as the second information, and likewise the second information may be referred to as the first information. Depending on the context, the words “if” and “in the case that” used here may be interpreted as “when” or “in response to determining”.

Description will now be made in detail to embodiments of the disclosure, examples of which are illustrated in the accompanying drawings, in which the same numbers represent the same or similar elements throughout. The embodiments described below with reference to the accompanying drawings are exemplary only and are intended to interpret the disclosure, but are not to be construed as a limitation of this disclosure.

For convenience of understanding, the terms in this disclosure are introduced first.

### 1. Beam Correspondence

A terminal may determine an uplink sending beam of the terminal based on a downlink receiving beam or determine a downlink receiving beam of the terminal based on an uplink sending beam.

### 2. Small Data Transmission (SDT)

In an SDT scenario, the terminal may send small data directly to a network device based on resources configured on the network device when the terminal is in a radio resource control (RRC) IDLE/INACTIVE state.

For example, the terminal in the idle or inactive state may directly send data to the network device in the following procedures:
a random access (RA) process of an initial access, that is, sending the small data by an Msg3 or an MsgA;
a 4-step RA process of the initial access (or, called a 4-step RACH SDT), that is, sending the small data by an Msg3;
a 2-step RA process of an initial access (or, called a 2-step RACH SDT), that is, sending the small data by an MsgA; or
a configured grant (CG) SDT service process, that is, sending the small data by a dedicated physical uplink shared channel (PUSCH) resource (such as a configured grant (CG) resource) configured by the network device; or a preallocated uplink resource (PUR).

### 3. Random Access Channel Occasion (RO)

A time-frequency domain resource occupied by a random access channel (RACH) format.

In order to better understand the random access method in embodiments of the disclosure, description is made below to a communication system to which embodiments of the disclosure are applicable.

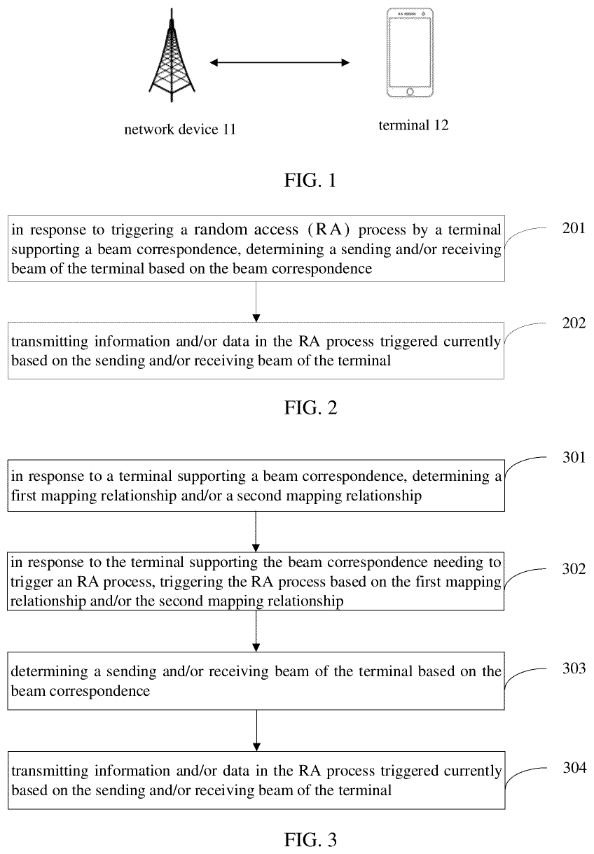

Please refer to FIG. 1, which is a schematic diagram illustrating a communication system according to an embodiment of the disclosure. The communication system may include but is not limited to a network device and a terminal. The number and form of the device illustrated in FIG. 1 are for example and do not constitute a limitation on embodiments of the disclosure, and may include two or more network devices and two or more terminals in a practical application. For example, the communication system illustrated in FIG. 1 includes a network device 11 and a terminal 12.

It should be noted that a technical solution of embodiments of the disclosure may be applied to various communication systems, such as, a long term evolution (LTE) system, a 5th generation (5G) mobile communication system, a 5G new radio (NR) system, or other new mobile communication systems in the future.

The network device 11 in embodiments of the disclosure is an entity for transmitting or receiving a signal in a network side. For example, the network device 11 may be an evolved NodeB (eNB), a transmission reception point (TRP), a next generation NodeB (gNB) in an NR system, or an access node in a base station or a wireless fidelity (WiFi) system in other mobile communication systems in the future. A detailed technology and a detailed device form employed by the network device are not limited in embodiments of the disclosure. The network device in embodiments of the disclosure may be combined by a central unit (CU) and a distributed unit (DU). The CU may also be called a control unit. A protocol layer of the network device, such as the base station, may be separated by employing a CU-DU structure. Some functions of the protocol layer are centrally controlled by the CU, while some or all of remaining functions of the protocol layer are distributed in the DU, and the DU is controlled by the CU.

The terminal 12 in embodiments of the disclosure is an entity for receiving or transmitting a signal in a user side, such as a mobile phone. The terminal may also be called a terminal device, a user equipment (UE), a mobile station (MS), a mobile terminal (MT), etc. The terminal may be a car with a communication function, a smart car, a mobile phone, a wearable device, a Pad, a computer with a wireless receiving and sending function, a virtual reality (VR) terminal, an augmented reality (AR) terminal, a wireless terminal in an industrial control, a wireless terminal in self-driving, a wireless terminal in a remote medical surgery, a wireless terminal in a smart grid, a wireless terminal in a transportation safety, a wireless terminal in a smart city, a wireless terminal in a smart home and so on. A detailed technology and detailed device form employed in the terminal are not limited in embodiments of the disclosure.

It is understood that the communication system in embodiments of the disclosure is intended to illustrate the technical solution in embodiments of the disclosure more clearly, does not constitute a limitation of the technical solution in embodiments of the disclosure. The skilled in the art may know that the technical solution in embodiments of the disclosure is equally applicable to a similar technical problem, with an evolution of a system architecture and an emergence of a new service scene.

Description is made in detail below to a random access method/apparatus/device and a storage medium in embodiments of the disclosure with reference to the accompanying drawings.

FIG. 2 is a flow chart illustrating a random access method according to an embodiment of the disclosure. The random access method is performed by a terminal. As illustrated in FIG. 2, the random access method may include the following.

At block 201, in response to triggering an RA process by a terminal supporting a beam correspondence, a sending and/or receiving beam of the terminal is determined based on the beam correspondence.

In an embodiment of the disclosure, the RA process may include one of: an RA process related to an SDT (hereafter referred to as an RA-SDT process); or an RA process related to a non-SDT (hereafter referred to as an RA-non-SDT process).

In an embodiment of the disclosure, the above beam correspondence is a beam correspondence that does not need a beam scanning, that is, a beam correspondence that does not need a downlink beam scanning and/or uplink beam scanning.

In addition, in an embodiment of the disclosure, based on a preset protocol agreement, the terminal supporting the beam correspondence should realize a transmission in the RA process based on the beam correspondence.

Further, in an embodiment of the disclosure, after the RA process is triggered by the terminal supporting the beam correspondence, the terminal generally needs to indicate to a network device whether the RA process triggered by the terminal is an RA process of realizing the transmission based on the beam correspondence. In this way, in the case that the RA process is the RA process of realizing the transmission based on the beam correspondence, the network device may further determine whether the network device intends to realize the transmission in the RA process triggered currently based on the beam correspondence of the terminal.

In an embodiment of the disclosure, the way by which the terminal indicates to the network device whether the RA process is the RA process of realizing the transmission based on the beam correspondence may include the following.

Way one: the RA process is triggered by the terminal based on some specific ROs and/or preambles to implicitly indicate to the network device whether the RA process triggered by the terminal is the RA process of realizing the transmission based on the beam correspondence.

In detail, in an embodiment of the disclosure, the terminal supporting the beam correspondence may determine a first mapping relationship and/or a second mapping relationship firstly. The first mapping relationship may include: a first RO and/or a first preamble corresponding to the RA-SDT process. The first RO is used to: indicate that the terminal realizes a transmission in a triggered RA-SDT process this time based on the beam correspondence in the case that an RO corresponding to the triggered RA-SDT process is the first RO. The first preamble is used to: indicate that the terminal realizes the transmission in the triggered RA-SDT process this time based on the beam correspondence in the case that a preamble corresponding to the triggered RA-SDT process is the first preamble. The second mapping relationship includes: a second RO and/or a second preamble corresponding to the RA-non-SDT process. The second RO is used to: indicate that the terminal realizes a transmission in a triggered RA-non-SDT process this time based on the beam correspondence in the case that an RO corresponding to the triggered RA-non-SDT process is the second RO, and the second preamble is used to: indicate that the terminal realizes the transmission in the triggered RA-non-SDT process this time based on the beam correspondence in the case that a preamble corresponding to the triggered RA-non-SDT process is the second preamble.

After the terminal supporting the beam correspondence determines the first mapping relationship and/or the second mapping relationship, in the case that the terminal triggers the RA-SDT process, the first RO and/or the first preamble is determined based on the first mapping relationship, and the RA-SDT process is triggered based on the first RO and/or the first preamble; and in the case that the terminal triggers (or initiates) the RA-non-SDT process, the second RO and/or second preamble is determined based on the second mapping relationship, and the RA-non-SDT process is triggered based on the second RO and/or second preamble.

It may be seen from the above that the network device only needs to determine whether the RO corresponding to the RA process triggered by the terminal is the first RO or the second RO above, and/or whether the preamble corresponding to the RA process triggered by the terminal is the first preamble or the second preamble above, and then determines whether the RA process triggered currently by the terminal is the RA process of realizing the transmission based on the beam correspondence.

Way two: the terminal indicates whether the RA process triggered by the terminal is the RA process of realizing the transmission based on the beam correspondence by reporting capability information to the network device.

In detail, in an embodiment of the disclosure, the terminal may report the capability information to the network device. The capability information indicates whether the terminal supports the beam correspondence in the RA process. The protocol agrees that, for the terminal supporting the beam correspondence, the terminal should realize the transmission in the RA process based on the beam correspondence. Thus, when the capability information received by the network device from the terminal indicates that the terminal supports the beam correspondence in the RA process, the network device may directly know that the RA process triggered by the terminal should be the RA process of realizing the transmission based on the beam correspondence.

Furthermore, it should be noted that in an embodiment of the disclosure, in the case that the terminal reports the capability information to the network device to indicate whether the RA process triggered by the terminal is the RA process of realizing the transmission based on the beam correspondence, the network device, based on the capability information reported by the terminal, may directly know whether the RA process triggered by the terminal is the RA process of realizing the transmission based on the beam correspondence. Therefore, the terminal does not need to trigger the RA process based on some specific ROs and/or preambles (such as the first RO, the second RO, the first preamble, or the second preamble mentioned above) to indicate to the network device whether the triggered RA process is the RA process of realizing the transmission based on the beam correspondence, thus the terminal may trigger the RA process based on any RO and/or preamble.

In addition, in an embodiment of the disclosure, the capability information above may be carried in an information domain, such as an information domain IE beam correspondence-ra-SDT-r18 ENUMERATED {supported}.

Further, in an embodiment of the disclosure, the above way for determining the sending and/or receiving beam of the terminal based on the beam correspondence may include: determining a receiving beam used when the terminal receives a synchronization signal block (SSB) associated with an RO and/or a preamble corresponding to the RA process triggered currently as the receiving beam of the terminal; and determining the sending beam of the terminal based on the beam correspondence and the receiving beam of the terminal, that is, determining the receiving beam of the terminal as the sending beam of the terminal simultaneously based on the beam correspondence. In other words, the terminal may also perform an uplink sending on the receiving beam of the terminal.

At block 202, information and/or data in the RA process triggered currently is transmitted based on the sending and/or receiving beam of the terminal.

In detail, in an embodiment of the disclosure, in response to the RA process triggered currently being the RA-SDT process, the information and the data may be sent to the network device based on the sending beam of the terminal, and information and data sent by the network device may be obtained based on the receiving beam of terminal. In response to the RA process triggered currently being the RA-non-SDT process, the information may be sent to the network device based on the sending beam of the terminal, and information sent by the network device may be received based on the receiving beam of the terminal.

For example, the terminal may use the sending beam of the terminal to send small data in a msg 1/msg3/msgA/RA-SDT process to the network device, and use the receiving beam of the terminal to receive small data in a msg2/msg4/msgB/RA-SDT process sent by the network device.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

FIG. 3 is a flow chart illustrating a random access method according to an embodiment of the disclosure. The method is performed by a terminal. As illustrated in FIG. 3, the random access method may include the following.

At block 301, in response to a terminal supporting a beam correspondence, a first mapping relationship and/or a second mapping relationship is determined.

At block 302, in response to the terminal supporting the beam correspondence needing to trigger (or initiate) an RA process, the RA process is triggered based on the first mapping relationship and/or the second mapping relationship.

At block 303, a sending and/or receiving beam of the terminal is determined based on the beam correspondence.

At block 304, information and/or data in the RA process triggered currently is transmitted based on the sending and/or receiving beam of the terminal.

For detailed description of blocks 301 to 304, please refer to the description of the above embodiments.

In conclusion, with the random access method in the embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

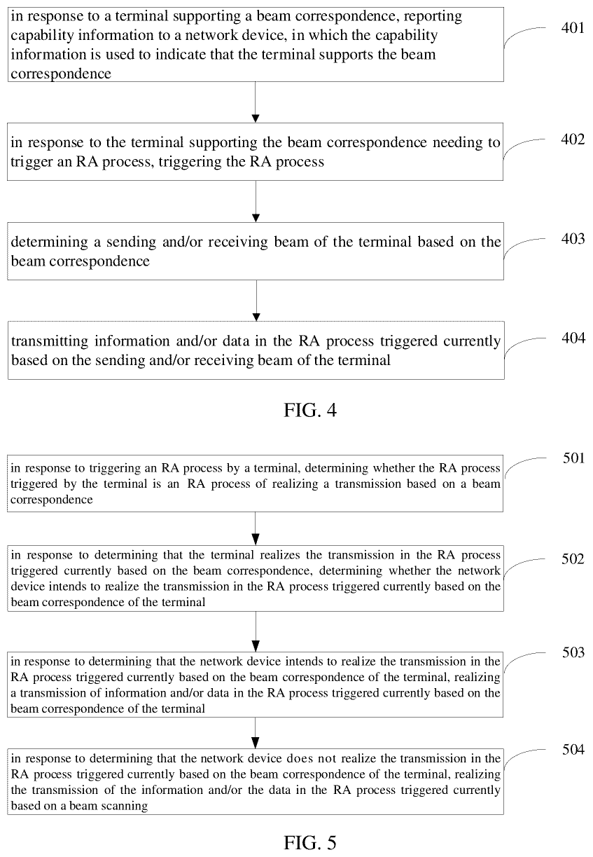

FIG. 4 is a flow chart illustrating a random access method according to an embodiment of the disclosure. The method is performed by a terminal. As illustrated in FIG. 4, the random access method may include the following.

At block 401, in response to a terminal supporting a beam correspondence, capability information is reported to a network device, in which the capability information is used to indicate that the terminal supports the beam correspondence.

At block 402, in response to the terminal supporting the beam correspondence needing to trigger (or initiate) an RA process, the RA process is triggered.

In an embodiment of the disclosure, when the terminal supporting the beam correspondence reports the capability information to the network device, and the capability information indicates that the terminal supports the beam correspondence, the terminal may trigger the RA process without some specific ROs and/or preambles (such as the first RO, the second RO, the first preamble, or the second preamble mentioned above) when triggering the RA process, but may trigger the RA process based on any RO and/or preamble.

At block 403, a sending and/or receiving beam of the terminal is determined based on the beam correspondence.

At block 404, information and/or data in the RA process triggered currently is transmitted based on the sending and/or receiving beam of the terminal.

For detailed description of blocks 401 to 404, please refer to the description of the above embodiments.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

FIG. 5 is a flow chart illustrating a random access method according to an embodiment of the disclosure. The method is performed by a network device. As illustrated in FIG. 5, the random access method may include the following.

At block 501, in response to triggering an RA process by a terminal, it is determined whether the RA process triggered by the terminal is an RA process of realizing a transmission based on a beam correspondence.

In an embodiment of the disclosure, the RA process includes one of: an RA-SDT process; and an RA-non-SDT process.

In an embodiment of the disclosure, the beam correspondence is a beam correspondence that does not need a beam scanning (such as an uplink scanning and or a downlink scanning).

In addition, in an embodiment of the disclosure, the way by which the network device determines whether the RA process triggered by the terminal is the RA process of realizing the transmission based on the beam correspondence may include one of the following.

Way one: based on an RO and/or a preamble corresponding to the RA process triggered by the terminal, it is determined whether the RA process triggered by the terminal is the RA process of realizing the transmission based on the beam correspondence.

In detail, the network device may determine a first mapping relationship and/or a second mapping relationship firstly. The first mapping relationship may include: a first RO and/or a first preamble corresponding to the RA-SDT process. The first RO is used to: indicate that the terminal realizes a transmission in a triggered RA-SDT process this time based on the beam correspondence in the case that an RO corresponding to the triggered RA-SDT process is the first RO. The first preamble is used to: indicate that the terminal realizes the transmission in the triggered RA-SDT process this time based on the beam correspondence in the case that a preamble corresponding to the triggered RA-SDT process is the first preamble. The second mapping relationship includes: a second RO and/or a second preamble corresponding to the RA-non-SDT process. The second RO is used to: indicate that the terminal realizes a transmission in a triggered RA-non-SDT process this time based on the beam correspondence in the case that an RO corresponding to the triggered RA-non-SDT process is the second RO. The second preamble is used to: indicate that the terminal realizes the transmission in the triggered RA-non-SDT process this time based on the beam correspondence in the case that a preamble corresponding to the triggered RA-non-SDT process is the second preamble.

After the first mapping relationship and/or the second mapping relationship is determined, a type of the RA process triggered currently is determined. In response to the RA process triggered currently being the RA-SDT process, in the case that the RO and/or the preamble corresponding to the RA process triggered currently is the first RO and/or the first preamble, it is determined that the RA process triggered by the terminal is the RA process of realizing the transmission based on the beam correspondence. In response to the RA process triggered currently being the RA-non-SDT process, in the case that the RO and/or the preamble corresponding to the RA triggered currently is the second RO and/or the second preamble, it is determined that the RA process triggered by the terminal is the RA process of realizing the transmission based on the beam correspondence.

Way two: based on the capability information reported by the terminal, it is determined whether the RA process triggered by the terminal is the RA process of realizing the transmission based on the beam correspondence.

In detail, in an embodiment of the disclosure, the protocol agrees that, for the terminal supporting the beam correspondence, the terminal should realize the transmission in the RA process based on the beam correspondence. Thus, when the capability information reported by the terminal indicates that the terminal supports the beam correspondence in the RA process, the network device may directly determine that the RA process triggered by the terminal is the RA process of realizing the transmission based on the beam correspondence.

At block 502, in response to determining that the terminal realizes the transmission in the RA process triggered currently based on the beam correspondence, it is determined whether the network device intends to realize the transmission in the RA process triggered currently based on the beam correspondence of the terminal.

In an embodiment of the disclosure, a way for determining whether the network device intends to realize the transmission in the RA process triggered currently based on the beam correspondence of the terminal may include: determining whether the network device supports the beam correspondence; in response to the network device supporting the beam correspondence, determining that the network device intends to realize the transmission in the RA process triggered currently based on the beam correspondence of the terminal; and in response to the network device not supporting the beam correspondence, determining that the network device does not realize the transmission in the RA process triggered currently based on the beam correspondence of the terminal.

At block S503, in response to determine that the network device intends to realize the transmission in the RA process triggered currently based on the beam correspondence of the terminal, a transmission of information and/or data in the RA process triggered currently is realized based on the beam correspondence of the terminal.

In an embodiment of the disclosure, a way of realizing the transmission of the information and/or the data in the RA process triggered currently based on the beam correspondence of the terminal may include the following. A sending beam of an SSB associated with an RO and/or a preamble corresponding to the RA process triggered currently is determined as a sending beam of the network device. A receiving beam of the network device is determined based on the beam correspondence of the terminal and the sending beam of the network device, that is, the sending beam of the network device is also determined as the receiving beam of the network device based on the beam correspondence. In other words, the sending beam of the network device also receives information and or data sent by the terminal. Then, the information and/or the data in the RA process triggered currently from the terminal is received based on the receiving beam of the network device; and the information and/or the data in the RA process triggered currently is sent to the terminal based on the sending beam of the network device.

In an embodiment of the disclosure, in response to the RA process triggered currently being the RA-SDT process, the information and the data in the RA process triggered currently sent by the terminal are received; and in response to the RA process triggered currently being the RA-non-SDT process, the information in the RA process triggered currently sent by the terminal is received. In response to the RA process triggered currently being the RA-SDT process, the information and the data in the RA process triggered currently are sent to the terminal; and in response to the RA process triggered currently being the RA-non-SDT process, the information in the RA process triggered currently is sent to the terminal.

For example, the network device may use the receiving beam of the network device to receive small data in a msg1/msg3/msgA/RA-SDT process sent by the terminal, and use the sending beam of the network device to send small data in a msg2/msg4/msgB/RA-SDT process to the terminal.

It may be seen that, in embodiments of the disclosure, when the terminal transmits the information and/or the data in the RA process triggered based on the beam correspondence, the network device may also transmit the information and/or the data in the RA process triggered by the terminal based on the beam correspondence, thus reducing the overhead of the beam management. Further, the network device side does not need to perform a beam scanning, such that, the transmission process on the network device side is shortened, and the transmission efficiency is improved, on the basis of ensuring that the information and/or the data may be successfully transmitted.

At block 504, in response to determining that the network device does not realize the transmission in the RA process triggered currently based on the beam correspondence of the terminal, the transmission of the information and/or the data in the RA process triggered currently based on a beam scanning is realized.

In an embodiment of the disclosure, the transmission of the information and/or the data in the RA process triggered currently based on the beam scanning includes: determining a sending beam of an SSB associated with an RO and/or a preamble corresponding to the RA process triggered currently as a sending beam of the network device; sending the information and/or the data in the RA process triggered currently to the terminal by using the sending beam of the network device; and receiving the information and/or the data in the RA process triggered currently sent by the terminal by performing an uplink beam scanning based on the sending beam of the network device.

In an embodiment of the disclosure, the network device determines that the RA process triggered by the terminal is the RA process of realizing the transmission based on the beam correspondence, that is, the sending beam of the terminal and the receiving beam of the terminal are the same beam. The sending beam of the network device is essentially the sending beam of the SSB associated with the RO and/or the preamble corresponding to the RA process triggered currently, and the sending beam of the network device also has a beam correspondence with the sending beam of the terminal and the receiving beam of the terminal. Therefore, when the network device performs the uplink beam scanning above, the information and/or the data in the RA process triggered currently and sent by the terminal may be received by scanning the uplink beam in a small range near the sending beam of the network device, so a range of the beam scanning in the disclosure is small, thus improving the efficiency of the beam scanning, and insuring the transmission efficiency of the information and/or the data.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

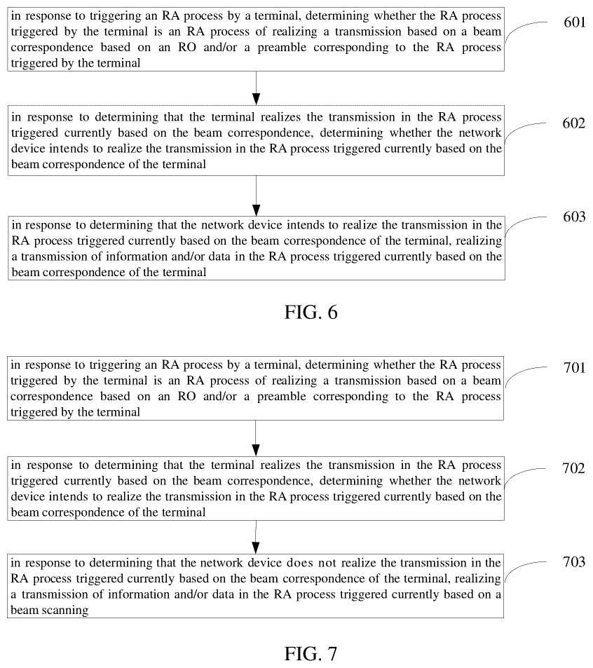

FIG. 6 is a flow chart illustrating a random access method according to an embodiment of the disclosure. The random access method is performed by a network device. As illustrated in FIG. 6, the random access method may include the following.

At block 601, in response to triggering an RA process by a terminal, it is determined whether the RA process triggered by the terminal is an RA process of realizing a transmission based on a beam correspondence, based on an RO and/or a preamble corresponding to the RA process triggered by the terminal.

At block 602, in response to determining that the terminal realizes the transmission in the RA process triggered currently based on the beam correspondence, it is determined whether the network device intends to realize the transmission in the RA process triggered currently based on the beam correspondence of the terminal.

At block 603, in response to determining that the network device intends to realize the transmission in the RA process triggered currently based on the beam correspondence of the terminal, realizing a transmission of information and/or data in the RA process triggered currently based on the beam correspondence of the terminal.

For detailed description of blocks 601 to 603, please refer to the description of the above embodiments.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

FIG. 7 is a flow chart illustrating a random access method according to an embodiment of the disclosure. The random access method is performed by a network device. As illustrated in FIG. 7, the random access method may include the following.

At block 701, in response to triggering an RA process by a terminal, it is determined whether the RA process triggered by the terminal is an RA process of realizing a transmission based on a beam correspondence based on an RO and/or a preamble corresponding to the RA process triggered by the terminal.

At block 702, in response to determining that the terminal realizes the transmission in the RA process triggered currently based on the beam correspondence, it is determined whether the network device intends to realize the transmission in the RA process triggered currently based on the beam correspondence of the terminal.

At step 703, in response to determining that the network device does not realize the transmission in the RA process triggered currently based on the beam correspondence of the terminal, a transmission of information and/or data in the RA process triggered currently is realized based on a beam scanning.

For detailed description of blocks 701 to 703, please refer to the description of the above embodiments.

In conclusion, with the random access method in the embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

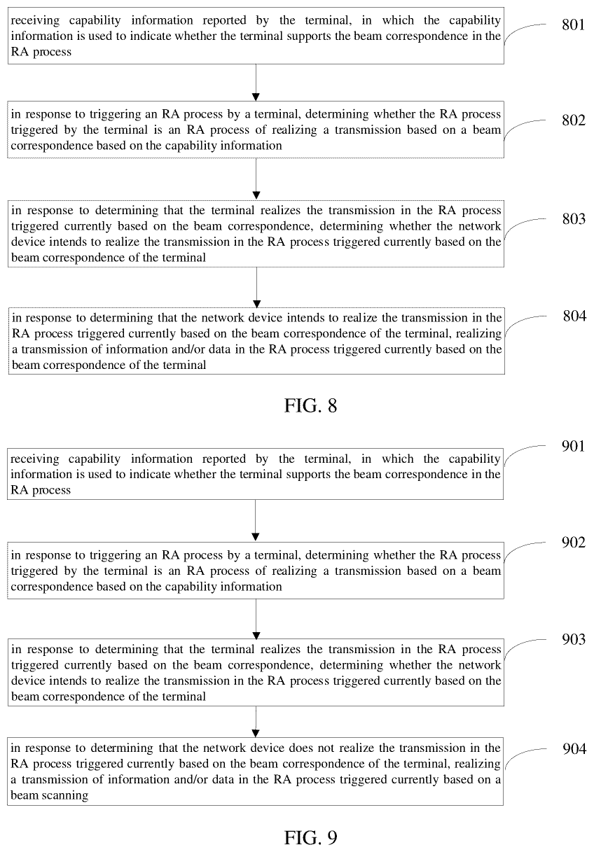

FIG. 8 is a flow chart illustrating a random access method according to an embodiment of the disclosure. The random access method is performed by a network device. As illustrated in FIG. 8, the random access method may include the following.

At block 801, capability information reported by the terminal is received, in which the capability information is used to indicate whether the terminal supports a beam correspondence in an RA process.

At block 802, in response to triggering the RA process by a terminal, it is determined based on the capability information whether the RA process triggered by the terminal is an RA process of realizing a transmission based on a beam correspondence.

At block 803, in response to determining that the terminal realizes the transmission in the RA process triggered currently based on the beam correspondence, it is determined whether the network device intends to realize the transmission in the RA process triggered currently based on the beam correspondence of the terminal.

At block 804, in response to determining that the network device intends to realize the transmission in the RA process triggered currently based on the beam correspondence of the terminal, a transmission of information and/or data in the RA process triggered currently is realized based on the beam correspondence of the terminal.

For detailed description of blocks 801 to 804, please refer to the description of the above embodiments.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

FIG. 9 is a flow chart illustrating a random access method according to an embodiment of the disclosure. The random access method is performed by a network device. As illustrated in FIG. 9, the random access method may include the following.

At block 901, capability information reported by the terminal is received, in which the capability information is used to indicate whether the terminal supports a beam correspondence in an RA process.

At block 902, in response to triggering the RA process by a terminal, it is determined based on the capability information whether the RA process triggered by the terminal is an RA process of realizing a transmission based on the beam correspondence.

At block 903, in response to determining that the terminal realizes the transmission in the RA process triggered currently based on the beam correspondence, it is determined whether the network device intends to realize the transmission in the RA process triggered currently based on the beam correspondence of the terminal.

At block 904, in response to determining that the network device does not realize the transmission in the RA process triggered currently based on the beam correspondence of the terminal, a transmission of information and/or data in the RA process triggered currently is realized based on a beam scanning.

For detailed description of blocks 901 to 904, please refer to the description of the above embodiments.

In conclusion, with the random access method in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

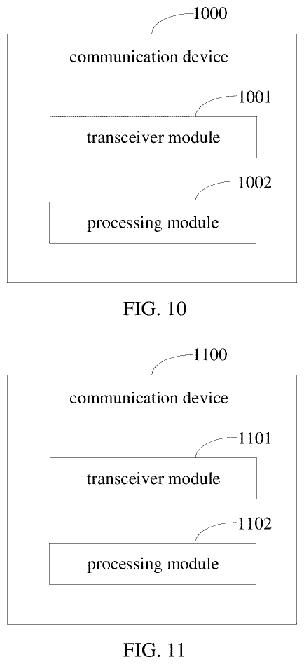

FIG. 10 is a block diagram illustrating a communication device according to an embodiment of the disclosure. As illustrated in FIG. 10, the device may include: a processing module, configured to, in response to triggering an RA process by a terminal supporting a beam correspondence, determine a sending and/or receiving beam of the terminal based on the beam correspondence; and a transceiver module, configured to transmit information and/or data in the RA process triggered currently based on the sending and/or receiving beam of the terminal.

In conclusion, with the communication device in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, and terminal side does not need to perform a beam scanning, such that the transmission process in the terminal side is shortened, and the transmission efficiency is improved, on the basis of ensuring that the information and/or the data may be successfully transmitted.

Alternatively, in an embodiment of the disclosure, the RA process includes one of: an RA process related to an SDT; or an RA process related to a non-SDT.

Alternatively, in an embodiment of the disclosure, the device is further configured to: determine a first mapping relationship and/or a second mapping relationship. The first mapping relationship includes: a first RO and/or a first preamble corresponding to the RA-SDT process. The first RO is used to: indicate that the terminal realizes a transmission in a triggered RA-SDT process this time based on the beam correspondence in the case that an RO corresponding to the triggered RA-SDT process is the first RO, and the first preamble is used to: indicate that the terminal realizes the transmission in the triggered RA-SDT process this time based on the beam correspondence in the case that a preamble corresponding to the triggered RA-SDT process is the first preamble. The second mapping relationship includes: a second RO and/or a second preamble corresponding to the RA-non-SDT process. The second RO is used to: indicate that the terminal realizes a transmission in a triggered RA-non-SDT process this time based on the beam correspondence in the case that an RO corresponding to the triggered RA-non-SDT process is the second RO, and the second preamble is used to: indicate that the terminal realizes the transmission in the triggered RA-non-SDT process this time based on the beam correspondence in the case that a preamble corresponding to the triggered RA-non-SDT process is the second preamble.

Alternatively, in an embodiment of the disclosure, the device is further configured to: determine the first RO and/or the first preamble based on the first mapping relationship in response to initiating the RA-SDT process, and trigger the RA-SDT process based on the first RO and/or the first preamble; and determine the second RO and/or the second preamble based on the second mapping relationship in response to initiating the RA-non-SDT process, and trigger the RA-non-SDT process based on the second RO and/or the second preamble.

Alternatively, in an embodiment of the disclosure, the device is further configured to: report capability information to a network device, in which the capability information is used to indicate whether the terminal supports the beam correspondence in the RA process.

Alternatively, in an embodiment of the disclosure, the processing module is further configure to: determine a receiving beam used when the terminal receives an SSB associated with an RO and/or a preamble corresponding to the RA process triggered currently as the receiving beam of the terminal; and determine the sending beam of the terminal based on the beam correspondence and the receiving beam of the terminal.

Alternatively, in an embodiment of the disclosure, the transceiver module is further configured to: send the information and the data to a network device based on the sending beam of the terminal in response to the RA process triggered currently being an RA-SDT process, and receive information and data sent by the network device based on the receiving beam of the terminal; and send the information to the network device based on the sending beam of the terminal in response to the RA process triggered currently being an RA-non-SDT process, and receive the information sent by the network device based on the receiving beam of the terminal.

Alternatively, in an embodiment of the disclosure, the beam correspondence is a beam correspondence that does not need a beam scanning.

FIG. 11 is a block diagram illustrating a communication device according to an embodiment of the disclosure. As illustrated in FIG. 11, the device may include: a processing module, configured to, in response to triggering an RA process by a terminal, determine whether the terminal realizes a transmission in the RA process triggered currently based on a beam correspondence, in which the processing module is further configured to determine whether the network device intends to realize the transmission in the RA process triggered currently based on the beam correspondence of the terminal in response to determining that the terminal realizes the transmission in the RA process triggered currently based on the beam correspondence; and a transceiver module, configured to realize the transmission of information and/or data in the RA process triggered currently based on the beam correspondence of the terminal in response to determining that the network device intends to realize the transmission in the RA process triggered currently based on the beam correspondence of the terminal. The transceiver module is further configured to realize the transmission of the information and/or the data in the RA process triggered currently based on a beam scanning in response to determining that the network device does not realize the transmission in the RA process triggered currently based on the beam correspondence of the terminal.

In conclusion, with the communication device in embodiments of the disclosure, the terminal supporting the beam correspondence may determine the sending and/or receiving beam of the terminal based on the beam correspondence in response to triggering the RA process by the terminal supporting the beam correspondence, and then the terminal supporting the beam correspondence transmits the information and/or the data in the RA process triggered currently based on the sending and/or receiving beam of the terminal. That is to say, in embodiments of the disclosure, for the terminal supporting the beam correspondence, the terminal may transmit the information and/or the data based on the beam correspondence in the RA process, thus reducing the overhead of the beam management. Meanwhile, the terminal side does not need to perform a beam scanning, such that the transmission process in the terminal side is shortened, and the transmission efficiency is improved, on the basis of ensuring that the information and/or the data may be successfully transmitted.

Alternatively, in an embodiment of the disclosure, the RA process includes one of: an RA process related to an SDT; or an RA process related to a non-SDT.

Alternatively, in an embodiment of the disclosure, the device is further configured to: determine a first mapping relationship and/or a second mapping relationship. The first mapping relationship includes: a first RO and/or a first preamble corresponding to the RA-SDT process. The first RO is used to: indicate that the terminal realizes a transmission in a triggered RA-SDT process this time based on the beam correspondence in the case that an RO corresponding to the triggered RA-SDT process is the first RO, and the first preamble is used to: indicate that the terminal realizes the transmission in the triggered RA-SDT process this time based on the beam correspondence in the case that a preamble corresponding to the triggered RA-SDT process is the first preamble. The second mapping relationship includes: a second RO and/or a second preamble corresponding to the RA-non-SDT process. The second RO is used to: indicate that the terminal realizes a transmission in a triggered RA-non-SDT process this time based on the beam correspondence in the case that an RO corresponding to the triggered RA-non-SDT process is the second RO, and the second preamble is used to: indicate that the terminal realizes the transmission in the triggered RA-non-SDT process this time based on the beam correspondence in the case that a preamble corresponding to the triggered RA-non-SDT process T is the second preamble.

Alternatively, in an embodiment of the disclosure, the processing module is further configure to: in response to the RA process triggered currently being the RA-SDT process, in the case that an RO and/or a preamble corresponding to the RA process triggered currently is the first RO and/or the first preamble, determine that the RA process triggered by the terminal is the RA process of realizing the transmission based on the beam correspondence; and in response to the RA process triggered currently being the RA-non-SDT process, in the case that the RO and/or the preamble corresponding to the RA process triggered currently is the second RO and/or the second preamble, determine that the RA process triggered by the terminal is the RA process of realizing the transmission based on the beam correspondence.

Alternatively, in an embodiment of the disclosure, the device is further configured to: receive capability information reported by the terminal, in which the capability information is used to indicate whether the terminal supports the beam correspondence in the RA process.

Alternatively, in an embodiment of the disclosure, the processing module is further configure to: in response to the capability information indicating that the terminal supports the beam correspondence in the RA process, determine that the RA process triggered by the terminal is the RA process of realizing the transmission based on the beam correspondence.

Alternatively, in an embodiment of the disclosure, the processing module is further configure to: in response to the network device supporting the beam correspondence, determine that the network device intends to realize the transmission in the RA process triggered currently based on the beam correspondence of the terminal; and in response to the network device not supporting the beam correspondence, determine that the network device does not realize the transmission in the RA process triggered currently based on the beam correspondence of the terminal.

Alternatively, in an embodiment of the disclosure, the transceiver module is further configured to: determine a sending beam of an SSB associated with an RO and/or a preamble corresponding to the RA process triggered currently as a sending beam of the network device; determine a receiving beam of the network device based on the beam correspondence of the terminal and the sending beam of the network device; receive the information and/or the data in the RA process triggered currently sent by the terminal based on the receiving beam of the network device; and send the information and/or the data in the RA process triggered currently to the terminal based on the sending beam of the network device.

Alternatively, in an embodiment of the disclosure, the transceiver module is further configured to: determine a sending beam of an SSB associated with an RO and/or a preamble corresponding to the RA process triggered currently as a sending beam of the network device; send the information and/or the data in the RA process triggered currently to the terminal by using the sending beam of the network device; and receive the information and/or the data in the RA process triggered currently sent by the terminal by performing an uplink beam scan based on the sending beam of the network device.

Alternatively, in an embodiment of the disclosure, the transceiver module is further configured to: in response to the RA process triggered currently being an RA-SDT process, receive the information and the data in the RA process triggered currently sent by the terminal; and in response to the RA process triggered currently being an RA-non-SDT process, receive the information in the RA process triggered currently sent by the terminal; and the transceiver module is further configured to: in response to the RA process triggered currently being the RA-SDT process, send the information and the data in the RA process triggered currently to the terminal; and in response to the RA process triggered currently being the RA-non-SDT process, send the information in the RA process triggered currently to the terminal.

Alternatively, in an embodiment of the disclosure, the beam correspondence is a beam correspondence that does not need a beam scanning.

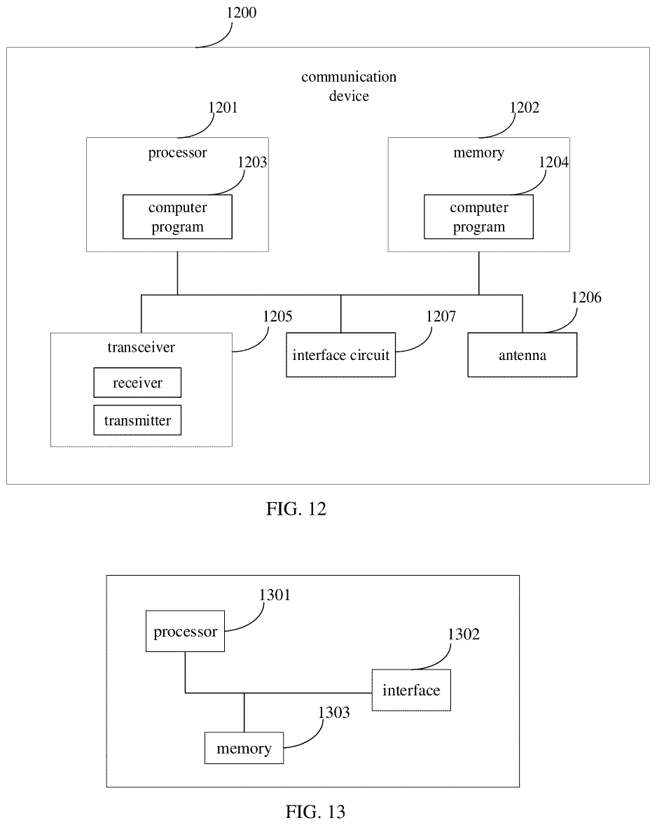

Please refer to FIG. 12, which is a block diagram illustrating a communication device 1200 according to an embodiment of the disclosure. The communication device 1200 may be a network device, a terminal, or a chip, a chip system, a processor, etc. supporting the network device to implement the above method, or a chip, a system on a chip, a chip system, a processor, etc. supporting the terminal to implement the above methods. The device may be configured to implement the methods in the above method embodiments, which is described in the above method embodiments.

The communication device 1200 may include one or more processors 1201. The processor 1201 may be a general purpose processor or a special purpose processor, such as a baseband processor or a central processing unit. The baseband processor may be configured to process communication protocols and communication data, and the central processing unit may be configured to control communication devices (such as a base station, a baseband chip, a terminal, a terminal chip, a DU or a CU, etc.), execute computer programs, and process computer program data.

Alternatively, the communication device 1200 may also include one or more memories 1202 for storing a computer program 1204, and the processor 1201 executes the computer program 1204 to cause the communication device 1200 to perform the method in the above method embodiments. Alternatively, the memory 1202 may also store data. The communication device 1200 and the memory 1202 may be set up separately or integrated together.

Alternatively, the communication device 1200 may also include a transceiver 1205 and an antenna 1206. The transceiver 1205 may be called a transceiver unit, a transceiver machine, or a transceiver circuit, etc. to implement the receiving and sending function. The transceiver 1205 may include a receiver and a transmitter, in which the receiver may be called a receiving machine or a receiving circuit, etc. to implement the receiving function; the transmitter may be called a sending machine or a sending circuit, etc. to implement the sending function.

Alternatively, the communication device 1200 may also include one or more interface circuits 1207. The interface circuit 1207 is configured to receive code instructions and transmit the code instructions to the processor 1201. When the processor 1201 runs the code instructions, the communication device 1200 is caused to perform the method in the above method embodiments.

In an implementation, the processor 1201 may include a transceiver for implementing the receiving function and the sending function. For example, the transceiver may be a transceiver circuit, or an interface, or an interface circuit. The transceiver circuit, the interface, or the interface circuit for implementing the receiving function and the sending function may be separate or integrated. The transceiver circuit, the interface, or the interface circuit may be configured to read and write code/data, or the transceiver circuit, the interface, or the interface circuit may be configured to transmit signals.

In an implementation, the processor 1201 may store a computer program 1203. When the computer program 1203 runs in the processor 1201, the communication device 1200 is caused to perform the method in the above method embodiments. The computer program 1203 may be solidified in the processor 1201, in which case the processor 1201 may be implemented by hardware.

In an implementation, the communication device 1200 includes a circuit that may implement the sending or receiving or communicating function in the above method embodiments. The processor and transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device in the above embodiments may be the network device or the terminal, but the scope of the communication device in the disclosure is not limited to this, and the structure of the communication device may not be limited by FIG. 12. The communication device may be an independent device or part of a larger device. For example, the communication device may be:
(1) an independent IC, a chip, a chip system or a subsystem;
(2) a collection including one or more IC, alternatively, the IC collection also including a storage component for storing data and a computer program;
(3) an ASIC, such as a modem;
(4) a module embedded in other device;
(5) a receiver, a terminal, a smart terminal, a cellular phone, a wireless device, a handheld phone, a mobile unit, a vehicle-mounted device, a network device, a cloud device, an artificial intelligence device, etc. ; or
(6) others.

For the case where the communication device may be the chip or the chip system, please refer to a structural diagram of the chip in FIG. 13. The chip illustrated in FIG. 13 includes a processor 1301 and an interface 1302. There may be one or more processors 1301, and there may be one or more interfaces 1302.

Alternatively, the chip also includes the memory 1303, which is configured to store a necessary computer program and data.

The skilled in the art may also understand that the various illustrative logical blocks and steps listed in embodiments of the disclosure may be implemented by electronic hardware, computer software, or their combination. Whether such a function is implemented in hardware or software depends on a specific application and a design requirement of an overall system. The skilled in the art may, for each specific application, use a variety of methods to implement the above function, but such implementation shall not be regarded as going beyond the scope of the protection of embodiments of the disclosure.

Embodiments of the disclosure also provide a readable storage medium for storing instructions. When the instructions are performed by a computer, the function of any one of the above method embodiments is performed.

Embodiments of the disclosure also provide a computer program product. When the computer program product is performed by a computer, the function of any one of the above method embodiments is performed.

In the above embodiments, the functions may be wholly or partially implemented by software, hardware, firmware, or any combination of them. When implemented by the software, the functions may be implemented in whole or in part in the form of the computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another computer-readable storage medium. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

The skilled in the art may understand that numerals like “first” and “second” in the disclosure are only for the convenience of description, and are not used to limit the scope of the embodiments of the disclosure, and also indicate a sequential order.

The term “at least one” in the disclosure may also be described as one or more, and the more may be two, three, four, or more, which is not limited in the disclosure. In embodiment of the disclosure, for one technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by each table in the disclosure may be configured or pre-defined. Values of information in the tables are only examples, and may be configured as other values, which are not limited in the disclosure. When the corresponding relationship between information and parameters is configured, it is not always necessary to configure all corresponding relationships indicated in the table. For example, in the table of the disclosure, corresponding relationships indicated by some rows may not be configured. For another example, appropriate transformations and adjustments, such as splitting and merging, may be made based on the above tables. Names of parameters illustrated in headers of the tables may be other names understandable by the communication device, and values or representations of the parameters may be other values or representations understandable by the communication device. When each table is implemented, other data structures may be used, for example, arrays, queues, containers, stacks, linear lists, pointers, linked lists, trees, graphs, structures, classes, heaps or hash tables may be used.

Pre-defined in the disclosure may be understood as defined, pre-defined, stored, pre-stored, pre-negotiated, pre-configured, solidified or pre-fired.

Those skilled in the related art may realize that, in combination with units and algorithm steps of the examples described in embodiments of the disclosure, may be implemented by an electronic hardware or a combination of an electronic hardware and a computer software. Whether the functions are performed by the hardware or the software depends on a specific application and a design constraint of the technical solution. The skilled in the art may employ different methods for each specific application to implement the described functions, but such implementation should not be considered as going beyond the scope of the disclosure.

Those skilled in the art may clearly understand that, for the convenience and conciseness of description, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the disclosure. Therefore, the protection scope of the disclosure shall be subject to the protection scope of claims.

1. A random access (RA) method, performed by a terminal, comprising:
in response to triggering an RA process by a terminal supporting a beam correspondence, determining at least one of a sending beam or a receiving beam of the terminal based on the beam correspondence; and
transmitting at least one of information or data in the RA process triggered currently based on the at least one of the sending beam or the receiving beam of the terminal.

2. The method of claim 1, wherein the RA process comprises one of:
an RA process related to a small data transmission (SDT); or
an RA process related to a non-SDT.

3. The method of claim 1, further comprising:
determining at least one of a first mapping relationship or a second mapping relationship,
wherein the first mapping relationship comprises: at least one of a first random access channel occasion (RO) or a first preamble corresponding to an RA process related to an SDT, wherein the first RO is used to: indicate that the terminal realizes a transmission in a triggered RA process related to the SDT this time based on the beam correspondence when an RO corresponding to the triggered RA process related to the SDT is the first RO, and the first preamble is used to: indicate that the terminal realizes the transmission in the triggered RA process related to the SDT this time based on the beam correspondence when a preamble corresponding to the triggered RA process related to the SDT is the first preamble; and
the second mapping relationship comprises: at least one of a second RO or a second preamble corresponding to an RA process related to a non-SDT, wherein the second RO is used to: indicate that the terminal realizes a transmission in a triggered RA process related to the non-SDT this time based on the beam correspondence when an RO corresponding to the triggered RA process related to the non-SDT is the second RO, and the second preamble is used to: indicate that the terminal realizes the transmission in the triggered RA process related to the non-SDT this time based on the beam correspondence when a preamble corresponding to the triggered RA process related to the non-SDT is the second preamble.

4. The method of claim 3, wherein triggering the RA process by the terminal supporting the beam correspondence comprises:
determining the at least one of the first RO or the first preamble based on the first mapping relationship in response to initiating the RA process related to the SDT, and triggering the RA process related to the SDT based on the at least one of the first RO or the first preamble; and
determining the at least one of the second RO or the second preamble based on the second mapping relationship in response to initiating the RA process related to the non-SDT, and triggering the RA process related to the non-SDT based on the at least one of the second RO or the second preamble.

5. The method of claim 1, further comprising:
reporting capability information to a network device, wherein the capability information is used to indicate whether the terminal supports the beam correspondence in the RA process.

6. The method of claim 1, wherein determining the at least one of the sending beam or the receiving beam of the terminal based on the beam correspondence comprises:
determining a receiving beam used when the terminal receives a synchronization signal block (SSB) associated with at least one of an RO or a preamble corresponding to the RA process triggered currently as the receiving beam of the terminal; and
determining the sending beam of the terminal based on the beam correspondence and the receiving beam of the terminal.

7. The method of claim 6, wherein transmitting the at least one of the information or the data in the RA process triggered currently based on at least one of the sending beam or receiving beam of the terminal comprises:
in response to the RA process triggered currently being an RA process related to an SDT, sending the information and the data to a network device based on the sending beam of the terminal, and receiving information and data sent by the network device based on the receiving beam of the terminal; and
in response to the RA process triggered currently being an RA process related to a non-SDT, sending the information to the network device based on the sending beam of the terminal, and receiving information sent by the network device based on the receiving beam of the terminal.

8. The method of claim 1, wherein the beam correspondence is a beam correspondence that does not need a beam scanning.

9. A random access (RA) method, performed by a network device, comprising:
in response to triggering an RA process by a terminal, determining whether the RA process triggered by the terminal is an RA process of realizing a transmission based on a beam correspondence;
in response to determining that the RA process triggered by the terminal is the RA process of realizing the transmission based on the beam correspondence, determining whether the network device intends to realize a transmission in the RA process triggered currently based on the beam correspondence of the terminal;
in response to determining that the network device intends to realize the transmission in the RA process triggered currently based on the beam correspondence of the terminal, realizing a transmission of at least one of information or data in the RA process triggered currently based on the beam correspondence of the terminal; and
in response to determining that the network device does not realize the transmission in the RA process triggered currently based on the beam correspondence of the terminal, realizing the transmission of the at least one of the information or the data in the RA process triggered currently based on a beam scanning.

10. The method of claim 9, wherein the RA process comprises one of:
an RA process related to a small data transmission (SDT); or
an RA process related to a non-SDT.

11. The method of claim 9, further comprising:
determining at least one of a first mapping relationship and/or a second mapping relationship,
wherein the first mapping relationship comprises: at least one of a first random access channel occasion (RO) or a first preamble corresponding to an RA process related to an SDT, wherein the first RO is used to: indicate that the terminal realizes the transmission in a triggered RA process related to the SDT this time based on the beam correspondence when an RO corresponding to the triggered RA process related to the SDT is the first RO, and the first preamble is used to: indicate that the terminal realizes the transmission in the triggered RA process related to the SDT this time based on the beam correspondence when a preamble corresponding to the triggered RA process related to the SDT is the first preamble; and
the second mapping relationship comprises: at least one of a second RO or a second preamble corresponding to an RA process related to a non-SDT, wherein the second RO is used to: indicate that the terminal realizes the transmission in a triggered RA process related to the non-SDT this time based on the beam correspondence when an RO corresponding to the RA process triggered and related to the non-SDT is the second RO, and the second preamble is used to: indicate that the terminal realizes the transmission in the triggered RA process related to the non-SDT this time based on the beam correspondence when a preamble corresponding to the triggered RA process related to the non-SDT is the second preamble.

12. The method of claim 11, wherein determining whether the RA process triggered by the terminal is the RA process of realizing the transmission based on the beam correspondence comprises:
in response to the RA process triggered currently being the RA process related to the SDT, when the at least one of the RO or the preamble corresponding to the RA process triggered currently is the at least one of the first RO or the first preamble, determining that the RA process triggered by the terminal is the RA process of realizing the transmission based on the beam correspondence; and
in response to the RA process triggered currently being the RA process related to the non-SDT, when the at least one of the RO or the preamble corresponding to the RA process triggered currently is the at least one of the second RO or the second preamble, determining that the RA process triggered by the terminal is the RA process of realizing the transmission based on the beam correspondence.

13. The method of claim 9, further comprising:
receiving capability information reported by the terminal, wherein the capability information is used to indicate whether the terminal supports the beam correspondence in the RA process.

14. The method of claim 13, wherein determining whether the RA process triggered by the terminal is the RA process of realizing the transmission based on the beam correspondence comprises:
in response to the capability information indicating that the terminal supports the beam correspondence in the RA process, determining that the RA process triggered by the terminal is the RA process of realizing the transmission based on the beam correspondence.

15. The method of claim 14, wherein determining whether the network device intends to realize the transmission in the RA process triggered currently based on the beam correspondence of the terminal comprises:
in response to the network device supporting the beam correspondence, determining that the network device intends to realize the transmission in the RA process triggered currently based on the beam correspondence of the terminal; and
in response to the network device not supporting the beam correspondence, determining that the network device does not realize the transmission in the RA process triggered currently based on the beam correspondence of the terminal.

16. The method of claim 9, wherein realizing the transmission of the at least one of the information or the data in the RA process triggered currently based on the beam correspondence of the terminal comprises:
determining a sending beam of a synchronization signal block (SSB) associated with at least one of an RO or a preamble corresponding to the RA process triggered currently as a sending beam of the network device;
determining a receiving beam of the network device based on the beam correspondence of the terminal and the sending beam of the network device;
receiving the at least one if the information or the data in the RA process triggered currently sent by the terminal based on the receiving beam of the network device; and
sending the at least one of the information or the data in the RA process triggered currently to the terminal based on the sending beam of the network device.

17. The method of claim 9, wherein realizing the transmission of at least one of the information or the data in the RA process triggered currently based on the beam scanning comprises:
determining a sending beam of an SSB associated with at least one of an RO or a preamble corresponding to the RA process triggered currently as a sending beam of the network device;
sending the at least one of the information or the data in the RA process triggered currently to the terminal by using the sending beam of the network device; and
receiving the at least one of the information or the data in the RA process triggered currently sent by the terminal by performing an uplink beam scan based on the sending beam of the network device,
wherein receiving the at least one of the information or the data in the RA process triggered currently sent by the terminal comprises:
in response to the RA process triggered currently being an RA process related to an SDT, receiving the information and the data in the RA process triggered currently sent by the terminal; and
in response to the RA process triggered currently being an RA process related to a non-SDT, receiving the information in the RA process triggered currently sent by the terminal;
wherein sending the at least one of the information or the data in the RA process triggered currently to the terminal comprises:
in response to the RA process triggered currently being the RA process related to the SDT, sending the information and the data in the RA process triggered currently to the terminal; and
in response to the RA process triggered currently being the RA process related to the non-SDT, sending the information in the RA process triggered currently to the terminal.

18. (canceled)

19. The method of claim 9, wherein the beam correspondence is the beam correspondence that does not need a beam scanning.

20. A terminal, comprising
a processor and a memory for storing a computer program executable by the processor,
wherein the processor is configured to:
in response to triggering an RA process by a terminal supporting a beam correspondence, determine one or both of a sending beam or receiving beam of the terminal based on the beam correspondence; and
transmit at least one of information or data in the RA process triggered currently based on the sending and/or receiving beam of the terminal.

21. A network device, comprising:
a processor and a memory for storing a computer program executable by the processor,
wherein the processor, when executing the computer program, implements the method of claim 9.

22-24. (canceled)
